(19) United States
(12) Patent Application Publication
(10) Pub. No.: US 2017/0262007 A1
(43) Pub. Date: Sep. 14, 2017

(54) MULTI-AGENT ORIENTED METHOD FOR FORECASTING-BASED CONTROL WITH LOAD PRIORITY OF MICROGRID IN ISLAND MODE

(71) Applicant: Macau University of Science and Technology, Macau (MO)

(72) Inventors: Li Zhiwu, Macau (MO); Mohamed Ghaieth Abidi, Carthage (TN); Moncef Ben Smida, Carthage (TN); Mohamed Khalgui, Carthage (TN); Naiqi Wu, Macau (MO)

(21) Appl. No.: 15/076,643

(22) Filed: Mar. 21, 2016

(30) Foreign Application Priority Data
Mar. 10, 2016 (AU) 2016100265

(51) Int. Cl. G05F 1/66; G05B 15/02; G05B 11/01; H02J 3/38

(52) U.S. Cl. CPC G05F 1/66; H02J 3/382; H02J 3/383; H02J 3/386; G05B 15/02; G05B 11/01; G05B 2219/39407

(57) ABSTRACT

The present invention deals with microgrids, which represent a new approach to integrate distributed energy resources economically reliably and efficiently. A microgrid can operate in a connected mode if it makes an energetic exchange with a main grid or in an island mode otherwise. In its island operation mode, a microgrid ensures its energy self-sufficiency. However, the availability of resources in this mode is greatly influenced by meteorological factors and the microgrid must satisfy the high requirements on intelligent power management in order to achieve high availability of energy. The present invention provides a multi-agent control system based on the production forecasting and loads shedding for high availability of the microgrid power supply.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Nomenclature:

PV Photovoltaic Generator
WT Wind Turbine
B Battery
GE Diesel Generator
P_{Source}(t) Electrical power exchanged between the source and the rest of the network at time t
P_{Load1}(t) Electrical power consumed by a critical load at time t
P_{Load2}(t) Electrical power consumed by a uncritical load at time t
En(t) Insolation at time t
V_{V}(t) Wind speed at time t
E_{charge} (t) Battery charge level at time t
E_{clim}(t) Sea State at a particular time t
N_{Charge}(t) Level of the fuel in the tank of the diesel generator at time t
E_{clim}_{₀} Nominal sea state
φₖ(t) Electrical power produced by the source k
SBWD Number of the days that the renewable energy sources are unavailable
A_{PS}(%) The availability rate of the power supply

### CLAIM FOR FOREIGN PRIORITY

This application claims priority under the Paris Convention to the Australia Patent Application No. 2016100265 filed Mar. 10, 2016; the disclosure of which is incorporated herein by reference in its entirety.

### FIELD OF THE INVENTION

The present invention relates to a microgrid energy distribution network. More particularly, the present invention relates to a method for managing connections of sources and loads to a network of microgrid to optimize power supply availability.

### BACKGROUND

The following references are cited in the specification. Disclosures of these references are incorporated herein by reference in their entirety.

### LIST OF REFERENCES

Abidi M G, Ben Smida M and Khalgui M (2015) New Forecasting-based Solutions for Optimal Energy Consumption in Microgrids with Load Shedding-Case Study: Petroleum Platform. In: Proceedings of the 5th International Conference on Pervasive and Embedded Computing and Communication Systems, February, pp. 289-296.
Anastasiadis A G, Tsikalakis A G and Hatziargyriou N D (2010) Operational and environmental benefits due to significant penetration of Microgrids and topology sensitivity. In: Proceedings of the IEEE Power and Energy Society General Meeting (PESGM '10), July, pp. 1-8.
Bae I and Kim J (2008) Reliability Evaluation of Customers in a Microgrid. IEEE Transactions on Power Systems 23(3): 1416-1422.
Bhoyar R R and Bharatkar S S (2013) Renewable energy integration in to microgrid: Powering rural Maharashtra State of India. In: Proceedings of the Annual IEEE India Conference (INDICON '13), December, pp. 1-6.
Colson C M, Nehrir M H and Wang C (2009) Ant colony optimization for microgrid multi-objective power management. In: Proceedings of the Power Systems Conference and Exposition (PSCE '09), March, pp. 1-7.
Gabbar A H and Abdelsalam A A (2014) Microgrid energy management in grid-connected and islanding modes based on SVC. Energy Conversion and Management 2014 86: 964-972.
Grosswindhager S, Kozek M, Voigt A and Haffner L (2013) Fuzzy predictive control of district heating network. International Journal of Modelling, Identification and Control 19(2): 161-170.
Hasselbring W, Heinemann D, Hurka J, Scheidsteger T, Bischofs L, Mayer C, Ploski J, Scherp G, Lohmann S, Hoyer-Klick C, Erbertseder T, Gesell G, Schroedter-Homscheidt M, Heilscher G, Rehwinkel J and Rensberg S (2006) WISENT: e-Science for Energy Meteorology. In: Proceedings of the Second IEEE International Conference on e-Science and Grid Computing (e-Science '06), December, pp. 93-100.
Hatziargyriou N (2014) Microgrids Architectures and Control. ISBN: 978-1-118-72068-4, 2014, Wiley-IEEE Press, United Kingdom.
Jiang Q, Xue M and Geng G (2013) Energy Management of Microgrid in Grid-Connected and Stand-Alone Modes. IEEE Transactions on Power Systems 2013 28(3): 3380-3389.
Kleissl J (2013) Solar Energy Forecasting and Resource Assessment. ISBN: 9780123971777, 2013, Academic Press, USA.
Kuznetsova E, Ruiz C, Li Y F and Zio E (2015) Analysis of robust optimization for decentralized microgrid energy management under uncertainty. International Journal of Electrical Power & Energy Systems 64: 815-832.
Kwasinski A (2010) Quantitative Evaluation of DC Microgrids Availability: Effects of System Architecture and Converter Topology Design Choices. IEEE Transactions on Power Electronics 26(3): 835-851.
Liu X and Su B (2008) Microgrids an integration of renewable energy technologies. In: Proceedings of the IEEE China International Conference on Electricity Distribution (CICED '08), December, pp. 1-7.
Logenthiran T, Srinivasan D, Khambadkone A M and Raj T S (2010) Optimal sizing of an islanded microgrid using Evolutionary Strategy. In: Proceedings of the IEEE 11th International Conference on Probabilistic Methods Applied to Power Systems (PMAPS '10), June, pp. 12-17.
Ma J, Yang F, Li Z and Qin J (2012) A renewable energy integration application in a MicroGrid based on model predictive control. In: Proceedings of the Power and Energy Society General Meeting (PESGM '12), July, pp. 1-6.
Mao M, Zhao Y, Sun S, Chang L, Cao Y, Su J, Sun M and Zhang G (2012) Quantitative analysis on economic impacts of installation at different sites on microgrids with multi-energy. In: Proceedings of the 3rd IEEE International Symposium on Power Electronics for Distributed Generation Systems (PEDG '12), June, pp. 668-673.
Nian Y, Liu S, Wu D and Liu J (2013) A method for optimal sizing of stand-alone hybrid pv/wind/battery system. In: Proceedings of the 2nd IET Conference on Renewable Power Generation (RPG '13), September, pp. 1-4.
Olivares D E, Canizares C A and Kazerani M (2014) A Centralized Energy Management System for Isolated Microgrids. IEEE Transactions on Smart Grid 5(4): 1864-1875.
Paulescu M, Paulescu E, Gravila P and Badescu V (2013) Weather Modeling and Forecasting of PV Systems Operation. ISBN: 978-1-4471-4649-0, 2013, Springer, UK.
Petko M (2004) Smart sensor for operational load measurement. Transactions of the Institute of Measurement and Control 26(2): 99-117.
Prema V and Uma Rao K (2014) Predictive models for power management of a hybrid microgrid A reviews. In: Proceedings of the International Conference on Advances in Energy Conversion Technologies (ICAECT '14), January, pp. 7-12.
Prodan I, Zio E (2014) A model predictive control framework for reliable microgrid energy management. International Journal of Electrical Power & Energy Systems 61: 399-409.
Song J, Bozchalui M C, Kwasinski A and Sharma R (2012) Microgrids availability evaluation using a Markov chain energy storage model: a comparison study in system architectures. In: Proceedings of the IEEE Transmission and Distribution Conference and Exposition (T&D '12), May, pp. 1-6.
Tang Y, Qi W, Sha Q, Chen N and Zhu L (2014) A combination forecast method based on cross entropy theory for wind power and application in power control. Transactions of the Institute of Measurement and Control 36(7): 891-897.
Wang H Y, Tong X Q, Li F, and Ren B Y (2011) Research on Energy Management and Its Control Strategies of Microgrid. In: Proceedings of the Asia-Pacific Conference on Power and Energy Engineering (APPEEC '11), March, pp. 1-5.
Wang X, Khemaissia I, Khalgui M, Li Z, Mosbahi O and Zhou M (2015) Dynamic Low-Power Reconfiguration of Real-Time Systems With Periodic and Probabilistic Tasks. IEEE Transactions on Automation Science and Engineering 12(1): 258-271.
Xing S (2012) Microgrid emergency control based on the stratified controllable load shedding optimization. In: Proceedings of the International Conference on Sustainable Power Generation and Supply (SUPERGEN '12), September, pp. 1-5.
Yuan P, Li P Q, Li X R and Xu Z H (2011) Strategy of research and application for the microgrid coordinated control. In: Proceedings of the International Conference on Advanced Power System Automation and Protection (APAP '11), October, pp. 873-878.
Yuan Z, Hou S J, Li D G, Gao W and Hu X S (2013) Optimal Energy Control Strategy Design for a Hybrid Electric Vehicle. Discrete Dynamics in Nature and Society Journal 2013.
Zhang H, Lai C S and Lai L L (2014) A novel load shedding strategy for distribution systems with distributed generations. In: Proceedings of the Innovative Smart Grid Technologies Conference Europe (ISGT-Europe '14), October, pp. 1-6.
Zhang J F, Khalgui M, Li Z W, Frey G, Mosbahi O and Ben Salah H (2015) Reconfigurable coordination of distributed discrete event control systems. IEEE Transactions on Control Systems Technology 23(1): 323-330.

A microgrid is a new concept of power systems, which aims to integrate many electrical power technologies efficiently and reliably (Mao et al. (2012); Anastasiadis et al. (2010)) in order to attain the power requirements of consumers (Liu and Su (2008)). A microgrid comprises renewable energy resources (RER), programmable sources (PrgS), distributed storage devices (DS), local loads and an energy management system (Hatziargyriou (2014)). In the case of temporarily or permanently main grid absence, the microgrid concept gives to the system the possibility to operate in an island mode (Jiang et al. (2013)). In this mode, a microgrid is an autonomous power system. It should be self-sufficient in the power production and be able to ensure a good quality (active and reactive power, voltage and frequency stability, power availability) of energy requested by consumers. In many sector applications, such as hospitals, research centers, offshore petroleum platforms and military bases, the service quality and mainly the power supply availability of a microgrid are regarded as paramount factors. In island mode and in the absence of renewable energy sources, the microgrid is power supplied by backup sources. The major constraint to ensure high power availability is the randomness and intermittent behavior of renewable energy sources (Hasselbring et al. (2006)), which can cause an imbalance of the energy between the production and the consumption.

In order to reduce the influence of intermittent sources behavior and to ensure the balance between the produced energy and the consumers demand, several studies are interested in the choice of adequate types and capacities of sources. These studies show good technical results, but in most cases, these solutions are economically expensive. Some studies have focused on the improvement of control strategies for different operating states of a microgrid (Gabbar and Abdelsalam (2014); Prodan and Zio (2014)). These control strategies, although they are real-time, they do not allow to have a high availability. To enhance the power supply availability of a microgrid, forecasting information can be taken into account in the control strategy (Kuznetsova et al. (2015); Grosswindhagei et al. (2013)). This strategy is to predict the availability of renewable sources. With this strategy, the high availability of the power supply can be improved by using the load shedding method based on promoting of high priority loads. In this study, the load shedding strategy is not only based on the real-time information, but also on the forecasting of meteorological factors which influence the sources availability. The load shedding strategy is reinforced by the proactive aspect forecasting. This proactive aspect allows to increase the autonomy of backup sources and to increase the availability of the system in the unfavorable weather conditions (Abidi et al. (2015)).

Nowadays, many human activities depend critically on a secure supply of energy. With growing concern about the availability of primary energy and increasing electricity demand, the use of renewable energy sources such as hydroelectric power, wind and solar becomes a necessity (Bhoyar and Bharatkar (2013)). The new generation of electric networks must integrate renewable energy into the electrical grid. Thus, the system security, safe operation, environmental protection, electricity quality, supply cost and energy efficiency must be considered in new ways according to a liberalized market environment.

A microgrid comprises networked generation sources and energy storage devices which are connected to the loads. The potential for improving the power supply availability is one of the main motivations behind the development and deployment of microgrids (Kwasinski (2010); Song et al. (2012) and Bae and Kim (2008)). The adequate choice of sources is the most important step to improve any availability (Logenthiran et al. (2010)). The hybridization can be on different types of sources (renewable source, programmable source and energy storage devices) or on the same type or on both. After an adequate choice, the sizing of these sources plays a mattering role to guarantee a required continuity of services. Many optimizing methodologies are proposed to calculate the optimum size of energy source and storage system by considering the availability criterion (Nian et al. (2013)). Some papers explore how the microgrids availability is impacted by its topology design. These works focus on the effects of the system architecture and the converter topology design choices on the system availability. These solutions present good technical results, but they are expensive.

The power management strategy has a significant impact on the electrical energy availability also (Wang H Y et al. (2011); Yuan Z et al. (2013)), especially in the case of an insufficient energy production or a hardware problem. Several research works have been interested in the impact of the control strategy on the different criteria of microgrid power supply, especially the power-quality and the power availability (Colson et al. (2009); Yuan P et al. (2011)). The power management can be ensured by various techniques, ranging from a centralized control approach to a fully decentralized one, depending on the rate of the responsibilities assumed by a central microgrid controller and distributed loads or energy resource controllers. In a centralized control, the power management responsibility is assigned to the central controller of the microgrid. This type of control is widely used for the microgrid in a connected mode. The microgrid central controller uses market prices of electricity. Based on grid security concerns, this controller determines the amount of power that the microgrid should import from the upstream distribution system. It optimizes the local production or consumption capabilities. With this type of control, the problems of optimization become extremely complex. Any modification of the installation (loads or sources) is going to influence the global control strategy. The decentralized approach suggests that this kind of constraints and sub-problems should be solved at the local level. The main responsibility is given to the micro-sources to optimize their production and to the local loads to control their consumption (FIG. 1). For this kind of control, the multi-agent theory presents an interesting and useful solution that can ensure a self-monitoring for each controllable element.

Whatever the approaches of control (centralized/decentralized approaches), especially in island mode, the real-time control is insufficient. The microgrid must have a control strategy based on the proactive reaction that takes production and consumption prediction into consideration to ensure the power balance of networks (Prema and Uma Rao (2014); Olivares et al. (2014); Ma et al. (2012)). The prediction of this quantity evolution allows us to face unsafe situations, and optimize production costs and power supply availability. Therefore, forecasting options may have a direct impact on the economic viability and supply availability of microgrids (Tang et al. (2014)). They allow them to enhance their competitiveness compared with a centralized generation. To maximize the efficiency of control strategy, the system state must be predictable and flexible.

### SUMMARY OF THE INVENTION

The present invention provides a hierarchical multi-agent solution for forecasting-based control with load priority. In the proposed model, the energy management system is subdivided into two management parts: production and consumption. In each part, a hierarchical multi-agent system following the master-slave model is used. The production management is assured by a super master agent and four master agents (master agent for each type of sources) and several slave agents (an agent by a micro source). The super master agent of production is used to choose the type of source to be integrated into the network based on the information collected by the master agents of production. These agents collect the useful information about the availability and autonomy state of their sources. They choose one, among them, that will be integrated into the network while taking into account the decision taken by the super master agent.

The consumption management is made in a similar way. A super master agent of consumption distributes the energy produced on the various classes of loads. Each class of loads includes the loads which have the same priority level. The control of each priority class is provided by a master agent. In the considered case, there are two classes: priority load and non-priority load classes. The choice of the level of production is done in coordination between the two super master agents and a “meteo” agent. The later obtains information about the weather forecasting from the meteorological services in order to predict the availability of renewable sources. In both production and consumption parts, the slave agents present the link between the control strategy and the equipment. They take the measures which concern sources availability or loads consumption and apply the orders of their masters. The communication between the various agents is made by tokens of information and control. This method gives to the microgrid management system the ability to make the right decision about the achievement refueling and to choose between using the energy produced to supply total loads and using the load shedding method. The use of this method increases the autonomy of backup sources (batteries and diesel generators) in the case of renewable sources unavailability (Xing (2012); Zhang H et al. (2014)).

The microgrid investigated in the present invention is an abstraction of an unmanned offshore petroleum platform located in the Tunisian coast. In bad weather conditions, the platform becomes inaccessible for refueling diesel generators. In this condition, the platform has to assure its energy self-sufficiency and avoid the total absence of electrical power supply. Between 2012 and 2014, six total stops of production are registered. These stops caused approximately one million dollars of losses for the Tunisian Government. These significant losses motivate us to develop a strategy that improves the availability and minimizes stops.

The present invention aims to provide a new control strategy to solve the real life problem on this Tunisian petroleum platform. The proposed control strategy is expected to minimize the negative influence of the intermittent behavior of the renewable sources availability on the platform production. The proposed control strategy is based on weather forecasting and the load shedding method. A mathematical approach is presented to show the different relationships between the different components of a microgrid and the influence of their yields by the meteorological factors (insolation, wind and good weather). The implementation of this strategy requires several input/output ports. The acquisition of weather forecasting data should be periodic. The management of energy flow must be at run-time. For technical and economic reasons, the FPGA Spartan 6 is chosen. This board presents a perfect solution for the multi input/output control strategy implementation. The use of FPGA to implement a multi-agent control represents another technical originality of the present invention. The experimental tests of the implemented mathematical model of the proposed strategy are developed. The experimental results show clearly a high improvement of power availability in the microgrid. The microgrid can avoid the short-term stops by increasing the autonomy of its backup sources. The platform can avoid losses estimated at least to 200,000 Dollars per year caused by the power unavailability.

According to an embodiment of the presently claimed invention, a computer-implemented method for managing connections of sources and loads to a network of a grid to optimize power supply availability, the grid comprising a set of loads, a set of sources, a set of agents for energy management, and a meteorological database having meteorological forecasting data, the method comprises: collecting, by at least one of the agents, sources production information from the set of the sources; collecting, by at least one of the agents, loads demand information from the set of the loads; determining, by at least one of the agents, a power generation level based on the collected sources production information, the loads demand information and the meteorological forecasting data; connecting or disconnecting, by at least one of the agents, some of the sources to the network based on the power generation level; and connecting or disconnecting, by at least one of the agents, some of the loads to the network based on the power generation level.

According to an embodiment of the presently claimed invention, a computer-implemented method for managing connections of sources and loads to a network of a grid to optimize power supply availability, the grid comprising a set of loads, a set of sources, and a set of agents for energy management, the method comprises: collecting, by a super master production agent, state information of the sources; collecting, by a super master consumption agent, state information of the loads; sending, by the super master production agent, a production information token to its related master production agents in order to determine a state of the sources, wherein the production information token visits the master production agents and returns thereafter to the super master production agent; sending, by each of the master production agents, an internal token to its slaves to collect information on an availability state of their micro-sources; calculating, by each of the master production agents, the availability state of the sources and filling its own cell in production token information when the master production agent receives the internal token again; collecting, by the super master consumption agent, information on the loads; sending, by the super master consumption agent, consumption token information to its related master loads agents; sending, by a priority loads agent, an internal load information token to its related slaves in order to determine their energy demands; calculating, by the priority load agent, a total demand; filling and passing, by the priority load agent, the internal load information token to a non-priority load agent; negotiating, by the super master production agent and the super master consumption agent, on a level of production being supplied by available sources to connected loads, while taking into account the information collected by both of the super master production and consumption agents and meteorological forecast information provided by a “meteo” agent; sending, by the super master production agent, a control token to the master production agents in order to integrate highest priority available source and disconnect the others; sending, by master agents of source to be disconnected, control tokens towards their slaves such that they disconnect their microstates; choosing, by a master agent of the source to be connected, micro-sources to be penetrated while meeting energy requirements, then sending a control token to its slaves; and coordinating, by the super master consumption agent, with the master load agents in order to connect most priority loads by taking into account the production level.

### BRIEF DESCRIPTION OF THE DRAWINGS

Embodiments of the present invention are described in more detail hereinafter with reference to the drawings, in which:

FIG. 1 depicts a decentralized control of a microgrid;

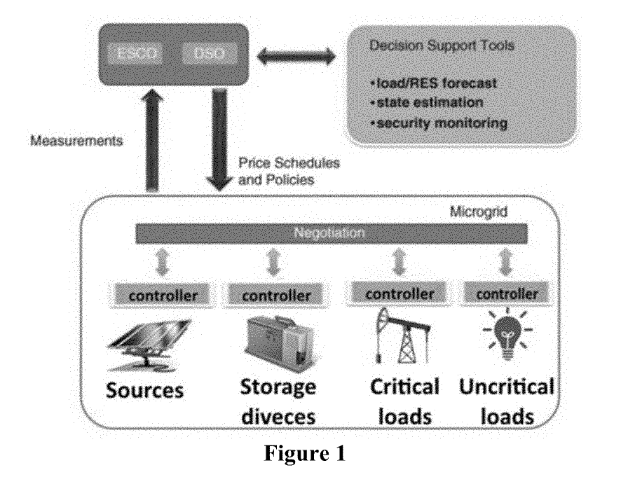

FIG. 2 depicts a microgrid network of the case study;

FIG. 3 depicts a considered microgrid;

FIG. 4 depicts a multi-agent system in the petroleum platform;

FIG. 5 depicts a production information token flow;

FIG. 6 depicts control strategy phases; and

FIG. 7a shows experimental results for the control strategy without load shedding, FIG. 7b shows experimental results for the control strategy with load shedding only, and FIG. 7c shows experimental results for the control strategy with load shedding and forecasting.

### DETAILED DESCRIPTION

In the following description, methods for managing connections of sources and loads to a network of a microgrid of energy generation and distribution to optimize power supply availability are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The description of the present invention is organized as follows: presenting the state of the art of microgrid power availability, explaining the problem and the contribution of this work, proposing the new architecture of the microgrid, providing the implementation of the proposed multi-agent architecture, evaluating the proposed solution.

To have this aspect of predictability and flexibility, a control strategy for the good management of the electrical energy in an island site is proposed. This control strategy combines forecasting and load shedding methods. This control strategy is not only based on the real states of sources, but it uses the forecasted meteorological data to control the integration state of sources and loads. The aim of the present invention is to provide an aspect of flexibility to the control strategy in order to ensure high availability in all weather conditions. The proposed control strategy can make the right decision about the achievement refueling and the use of the load shedding method. In a microgrid, the loads are not of the same importance. In certain cases, the elimination of some (uncritical) loads increases the operating time of critical loads without having any negative effect. If the system predicts an insufficiency of production, it disconnects non-priority loads in order to elongate the autonomy of the backup sources. This improvement of autonomy increases the electrical power availability for the priority loads. The forecast weather information is used to predict the availability of distributed energy resources in an island microgrid. The availability of the electrical energy in an isolated site presents one of the problems to be solved. The proposed control architecture is capable to assure high availability for critical loads.

Contrary to the classic solutions based essentially on the increase of production by the sources oversizing, the proposed solution is economically effective, especially for a marine platform where the weight and the congestion present major constraints. The choice of an approach with agents for the energy management gives to the system more flexibility in control. It also facilitates the adaptation of the control strategy to any change in the microgrid topology of the platform. Each change (increase of sources or loads) has a direct impact only on its corresponding agent.

Case Study and Problems:

One describes in this section the considered case study and introduces the problem.

Tunisian Petroleum Platform:

The microgrid investigated in the present invention is an islanded petroleum platform located in the Tunisian coast. The architecture of this microgrid adopted for this case study is composed of three photovoltaic generators, two wind turbines, four batteries, two diesel generators and four principal loads. Distributed energy resources are designed as follows: (i) Each renewable energy source (PV, wind turbine) is sized to be able to generate the electrical power supply required by both loads and batteries in favorable weather conditions, (ii) Each diesel generator is dimensioned to be able to produce the electrical energy required by the loads. The autonomy of this source is proportional to the fuel level in its tank and the power required by the loads, and (iii) Batteries are sized to be able to provide the electrical power supply required by loads with an autonomy proportional to their charge levels and the electrical power requested by loads. In its charging phase, the battery is considered as a load.

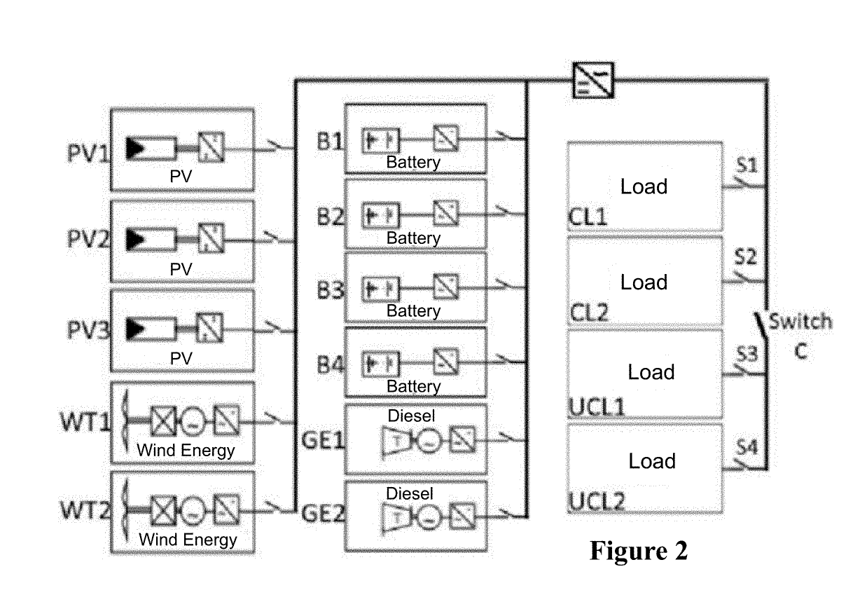

Loads can be classified into two classes: (i) Critical loads: For which the high availability of electrical power supply must be assured, and (ii) Uncritical loads: Which can be disconnected from the network in emergency cases. The microgrid adopted for this case study is composed of: three photovoltaic modules {PV1, PV2, PV3}, two wind turbines {WT1, WT2}, four batteries {B1, B2, B3, B4}, two diesel generators {GE1, GE2}, two critical loads {CL1, CL2}, and two uncritical loads {UCL1, UCL2} (FIG. 2).

Problems:

The petroleum platform can only operate in the island mode. It cannot have any recourse to a main electrical network. The microgrid must produce the needed energy in order to ensure its energy self-sufficiency. The problem is the intermittent nature of all the renewable energy sources.

The availability of renewable sources (photovoltaic generators and wind turbines) is relative to the meteorological terms (insolation and wind). The probability that these two meteorological factors are in the acceptable margin does not exceed 33% (Table 1 for insolation);

In the case of renewable source unavailability, the microgrid resorts to backup sources (batteries and diesel generators). These sources can ensure the power supply availability, but the availability of these sources is limited by their capacity ratings. In the considered platform, the backup system can ensure the energy demand of all the loads for a maximum duration of 3 days.

TABLE 1
Insolation rate in Tunis.

| Month | January | February | March | April | May | June |
|---|---|---|---|---|---|---|
| Ins(h) | 146 | 160 | 198 | 225 | 282 | 309 |
| Month | July | August | September | October | Novem- | Decem- |
| | | | | | ber | ber |
| Ins(h) | 357 | 329 | 258 | 214 | 174 | 149 |

| | |
|---|---|
| Total | 2804 hours/year |

If the downtime of the renewable sources exceeds the time that can be covered by the backup sources (autonomy) in the platform, then the electrical energy becomes totally unavailable and all the microgrid loads will be off-services (Equation 1). The control and communication systems are shutdown. Between 2012 and 2014, the platform recorded six blackouts caused by the long-term climatic fluctuations. These blackouts provoked approximately one million dollars of losses for the Tunisian Government. Therefore, it is necessary to develop a control strategy to avoid or at least minimize the downtime especially at critical loads.

The development and implementation of a multi-agent solution to control the case study (Petroleum Platform), based on Field Programmable Gate Arrays (FPGAs), is presented in the present invention. The control strategy implemented on the FPGA has an objective to manage the connection of sources and loads to the microgrid network. This strategy is based firstly on the real-time information about the production and consumption state of the various elements in the platform, and secondly on the weather forecast information. The real-time information concerns the production state of the renewable sources, the charge levels of the batteries, the fuel level in the tanks of the diesel generators, and loads energy demand.

New Architecture of Microgrid:

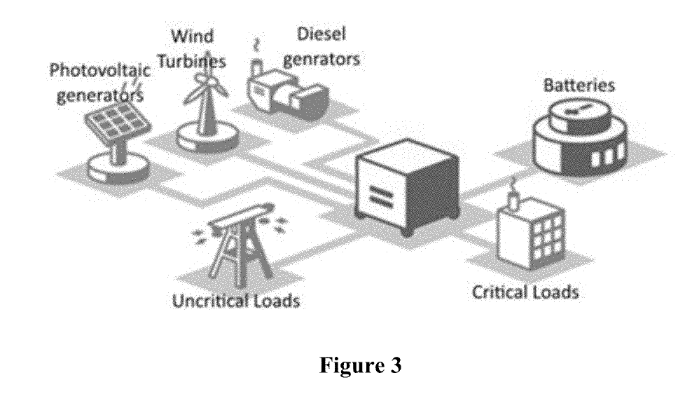

In this section, one presents the multi-agent architecture of microgrids (FIG. 3) as well as a mathematical formalization of agents.

Motivation:

The goal of the present invention is to develop a new automated intelligent control strategy based on real-time measurement and power generation forecasting (Wang X et al. (2015)). By minimizing the impact of the fluctuating and intermittent behavior of renewable sources, this strategy will be able to optimize the power supply availability. The proposed idea is to: (i) use real-time information (measures) to ensure the availability of electrical energy, and (ii) use forecasting data to find an idea about the availability of sources in the future and use all the information to generate a proactive reaction control. In the case of renewable energy sources unavailability, this proactive reaction gives to the system the possibility of minimizing the energy consumption by making a decision of load shedding, which is based on the state of non-renewable sources and meteorological forecasts, aiming also to increase the autonomy of these sources. The choice of loads to be shed is based on the production level and the load priority. A detailed mathematical model of this strategy is described in the next subsection.

Multi-Agent Architecture of Microgrids:

A microgrid comprises photovoltaic cells, wind turbines, batteries, diesel generators and loads. The control strategy of the microgrid is to solve many specific operational problems, and several decisions must be taken locally (Zhang J F et al. (2015)). For each kind of source or load, the controller must possess a degree of autonomy and intelligence. Thus, the multi-agent solution is chosen. This solution provides the most suitable paradigm for this type of control strategy due to its inherent advantages such as reactivity, proactivity and autonomy. In this subsection, one deals with the formalization of equipment as well as the proposed multi-agent system for a required high power availability.

Formalization of Equipment:

The platform (P) is composed of a set (φ_{cons}) cons of several distributed loads, and a set (φ_{prod}) of sources {photovoltaic arrays, wind turbines, batteries and diesel generators}. Loads in (φ_{cons}) can be classified into two groups: Critical (βₚ) and Uncritical (βₙₚ) loads.

On the platform, there is a multitude of loads of each type. There are N_{P} critical loads {β_{P}¹, . . . , β_{P}^{N}^{_{P}}} that should be always connected to the grid. There are N_{NP} uncritical loads {β_{NP}¹, . . . , β_{NP}^{N}^{_{NP}}} that can be disconnected in some cases. In this study, the microgrid is powered by four types of energy sources: (i) Photovoltaic Generators (S_{PV}), (ii) Wind Turbines (S_{WT}), (iii) Batteries (S_{B}), and (iv) Diesel Generators (S_{GE}). The set of distributed sources φ_{prod} is {S_{PV}, S_{WT}, S_{B}, S_{GE}}.

The number of sources varies from one type to another. One has N_{PV} Photovoltaic Generators, defining set S_{PV}={S_{PV}¹, . . . , S_{PV}^{N}^{_{PV}}}. One has N_{WT} Wind Turbines, defining set S_{WT}={S_{WT}¹, . . . , S_{WT}^{N}^{_{WT}}}. One has N_{B} Batteries, defining set S_{B}={S_{B}¹, . . . , S_{B}^{N}^{_{B}}}. One has N_{GE} Diesel Generators, defining set S_{GE}={S_{GE}¹, . . . , S_{GE}^{N}^{_{GE}}}. The platform also has a meteorological database. The data provided by this database are used in the production forecast.

New Agents for High Availability Power Supply:

A distributed multi-agent architecture is proposed for an intelligent power management in order to achieve a required high availability of energy.

Classification of Agents:

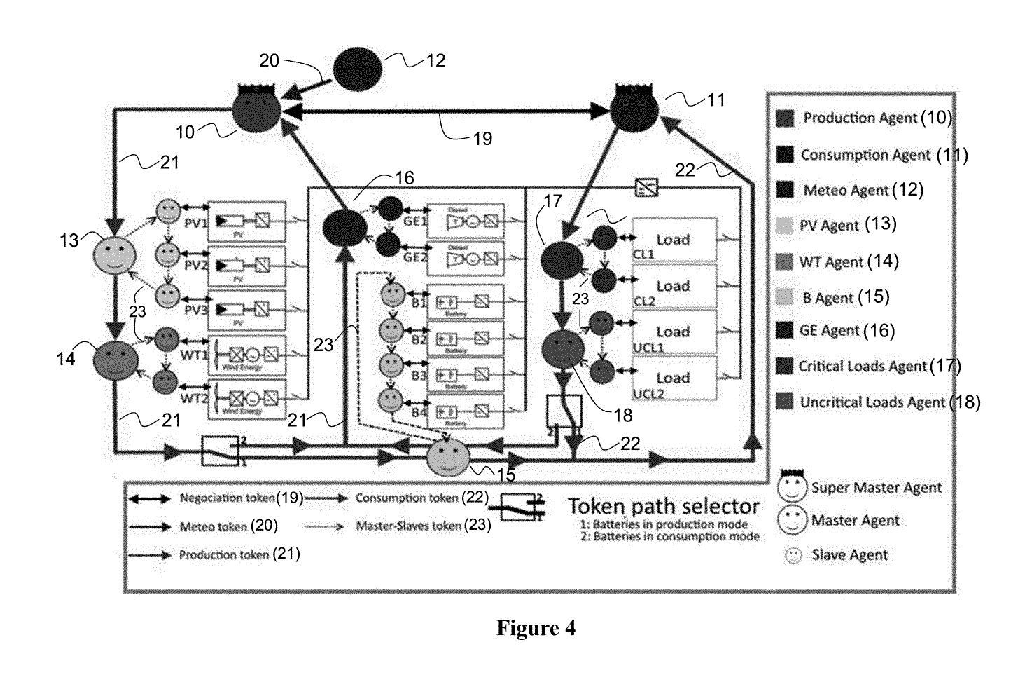

To construct a multi-agent system for the studied platform, the management of energy is provided mainly by various master and slave agents (FIG. 4). The agent M A_{prod} is the super master agent of production. Its role is to: (i) maintain the balance between the production and the consumption, (ii) calculate and make the prediction of the produced energy based on the agent M Aₘₑₜₑₒ, communicate with the consumption master agent and master agents of each type of source, (iv) collect the production power information from the agents M A_{PV}, M A_{WT}, M A_{B} and M A_{GE}, and (v) Control the state of penetration of sources. The agent (M A_{prod}) is in the higher level of {M A_{PV},M A_{WT},M A_{B},M A_{GE}}.

M A_{PV}, M A_{WT}, M A_{B} and M A_{GE} are respectively master agents of: Photovoltaic generators, wind turbines, batteries (in the production mode) and diesel generators. Each master agent can control and communicate with its slave agents.

Agent_{PV}(M A_{PV}) in charge of {S_{PV}¹, . . . , S_{PV}^{(N}^{_{PV}}⁾} is responsible of the photovoltaic production management. Agent_{WT}(M A_{WT}) in charge of {S_{WT}¹, . . . , S_{WT}^{(N}^{_{WT}}⁾} is responsible of the wind turbines production management. Agent_{B}(M A_{B}) in charge of {S_{B}¹, . . . , S_{B}^{(N}^{_{B}}⁾} is responsible of the batteries production management.

Agent_{GE}(M A_{GE}) in charge of {S_{GE}¹, . . . , S_{GE}^{(N}^{_{GE}}⁾} is responsible of the diesel generators production management. These agents are responsible of collecting information from their slaves and controlling their state of penetration. The super master agent of consumption is Agent(M A_{cons}) in charge of {M A_{P}, M A_{NP}}. Agent(M A_{P}) is responsible for critical loads consumption management. Agent(M A_{P}) in charge of {β_{P}¹, . . . , β_{P}^{(N}^{_{P}}⁾}. Agent_{NP}(M A_{NP}) is responsible for uncritical loads consumption management. Agent(M A_{NP}) is at the higher level of {β_{NP}¹, . . . , β_{NP}^{(N}^{_{NP}}⁾}.

The agent M A_{cons} is responsible of power demand management in the system. This agent communicates with priority and non-priority loads master agents to collect the power required by the loads. The super master agent of consumption informs the super master agent of production M A_{prod} about the amount of load request, and receives thereafter information about the produced power. Finally, it communicates with agents M A_{P} and M A_{NP} to control the connection state of their associated loads.

Agents M A_{P} and M A_{NP} are the critical (priority), uncritical (non-priority) loads agents and batteries (in the consumption mode). They are responsible of collecting information from associated slave loads and send this information to agent M A_{cons}. These slave agents are responsible of collecting information about energy demand of loads and applying the load shedding strategy.

The agent M Aₘₑₜₑₒ is responsible of storing the periodic meteorological forecasts for the next seven days. Nowadays, this type of forecasts presents a good precision (Kleissl (2013), Zhang J F et al. (2015)). M Aₘₑₜₑₒ provides information to the super master agent of production to estimate the production of sources. The meteorological forecasting data are inputs to the fixed problem and one supposes that they are precise. In the present invention, one works on the worst case. If a day is sunny with a probability=0.5, then it is assumed that one does not consider it sunny. A source is estimated available if the probability of availability exceeds a reliability threshold. The multi-agent system of this platform {P(Ag)} is composed of the different mentioned agents as follows:

$$\{ \begin{matrix}P ( Ag ) consists of \{ M {A}_{prod} , M {A}_{cons} , M {A}_{meteo} \} \\ \begin{matrix}Agent ( M {A}_{prod} ) is the higher level of \\ \{ M {A}_{PV} , M {A}_{WT} , M {A}_{B} , M {A}_{GR} \}\end{matrix} \\ Agent ( M {A}_{PV} ) in charge of \{ {S}_{PV}^{1} , … , {S}_{PV}^{( {N}_{PV} )} \} \\ Agent ( M {A}_{WT} ) in charge of \{ {S}_{WT}^{1} , … , {S}_{WT}^{( {N}_{WT} )} \} \\ Agent ( M {A}_{B} ) in charge of \{ {S}_{B}^{1} , … , {S}_{B}^{( {N}_{B} )} \} \\ Agent ( M {A}_{GE} ) in charge of \{ {S}_{FE}^{1} , … , {S}_{GE}^{( {N}_{GE} )} \} \\ Agent ( M {A}_{cons} ) is the higher level of \{ M {A}_{P} , M {A}_{NP} , M {A}_{B} \} \\ Agent ( M {A}_{P} ) in charge of \{ {β}_{P}^{1} , … , {β}_{P}^{( {N}_{P} )} \} \\ Agent ( M {A}_{NP} ) in charge of \{ {β}_{N P}^{1} , … , {β}_{N P}^{( {N}_{N P} )} \}\end{matrix} \qquad ( 2 )$$

Formalization of Agents:

In this subsection, one deals with the formalization of the proposed agents.

Slave Source Agents:

These agents present the link between the control system and the sources to be controlled. At this level, the platform supplies to the control system the required measures and receives the control order concerning the micro-sources states. For each kind of source, there is Nₖ micro-sources (Mₛ)(kε{PV; WT; B; GE}). Each micro-source Mₛ_{ₖ} can have both availability states Aₖ^{M}^{ₛ}: available (1) or not available (0). In the following equations, ┌x┐ represents ceiling(x).

$$\{ \begin{matrix}{A}_{PV}^{{M}_{s}} ( t ) = ⌈ \frac{{E}_{n} ( t )}{{E}_{{n}_{0}}} ⌉ - 1 \\ {A}_{WT}^{{M}_{s}} ( t ) = ⌈ \frac{{V}_{V} ( t )}{{V}_{{V}_{0}}} ⌉ - 1 \\ {A}_{B}^{{M}_{s}} ( t ) = ⌈ \frac{{E}_{Charge} ( t )}{{E}_{{Charge}_{0}}} ⌉ - 1 \\ {A}_{GE}^{{M}_{s}} ( t ) = ⌈ \frac{{N}_{Charge} ( t )}{{N}_{{Charge}_{0}}} ⌉ - 1\end{matrix} \qquad ( 3 )$$

where: Eₙ_{₀}, V_{V}_{₀}, E_{Charge}_{₀} and N_{Charge}_{₀} are the nominal values from which the sources are capable of producing energy.

Master Source Agents:

In term of availability A(t), all electrical energy sources (photovoltaic generators, wind turbines, batteries and diesel generators) can have two states: (1) available energy producer, and (0) unavailable energy producer. In its charging phase, a battery acts as a load that may consume excess production. In this phase the battery can have a third state (−1): load state of the battery. The different availability states of the different sources are summarized as follows:

$$\{ \begin{matrix}{A}_{PV} ( t ) ∈ \{ 1 , 0 \} \\ {A}_{WT} ( t ) ∈ \{ 1 , 0 \} \\ {A}_{B} ( t ) ∈ \{ 1 , 0 , - 1 \} \\ {A}_{GE} ( t ) ∈ \{ 1 , 0 \}\end{matrix} \qquad ( 4 )$$

Similar to sources, each micro-source Mₛ has its availability state Aᵢ^{M}^{ₛ}. If Rₖ of Nₖ micro-sources are available, this source is available. Rₖ is the minimal number of micro-sources which can assure the requested energy, i.e.,

$$\{ \begin{matrix}{A}_{k} ( t ) = 1 , {Σ}_{i = 1}^{{N}_{k}} {A}_{i}^{{M}_{s}} \geq {R}_{k} \\ {A}_{k} = 0 , otherwise\end{matrix} \qquad ( 5 )$$

where: 1≦Rₖ≦Nₖ, kε{PV, WT, B, GE}.

The master production agent selects the source that will supply the electrical energy to the microgrid. The selected source chooses among its available micro-sources that should be connected while respecting the rule Rₖ/Nₖ (equation 6). By using these agents, the system collects the real-time information on the energy production. The information collected allows the system to choose the sources to be penetrated to the grid. These agents are only responsible to choose the micro-sources, which must assure the energy production requested by the corresponding master agent of production. Cᵢ^{M}^{ₛ} is the penetration state of the i^{th} micro-source. One has:

Σᵢ₌₁^{N}^{ₖ}Cᵢ^{M}^{ₛ}=Rₖ (6)

The energy supplied to the microgrid by each source (φₖ) is the sum of the electrical production (P) of its micro-sources (Mₛ) which are connected to the microgrid.

$${ϕ}_{k} = {\sum }_{i = 1}^{{N}_{k}} {C}_{i}^{{M}_{{s}_{i}}} \cdot {P}_{i}^{{M}_{{s}_{i}}} \qquad ( 7 )$$

In the considered platform, the photovoltaic source (PV) is available if at least two between three photovoltaic fields are available. For other sources, they are available if one (at least) among their micro-sources is available. Only available sources (and micro-sources) can be connected to the grid. The most priority available source (spring) will be penetrated to the grid. In the present invention, the priority order of sources is (1) photovoltaic cells, (2) wind turbines, (3) batteries and (4) diesel generators. The penetration management strategy of sources to the microgrid (connecting/disconnecting) can be defined by the following equation:

$$\{ \begin{matrix}{C}_{PV} ( t ) = ⌈ \frac{{Σ}_{i = 1}^{{N}_{PV}} {A}_{i}^{{M}_{s} PV}}{{R}_{PV}} ⌉ - 1 \\ {C}_{WT} ( t ) = ( ⌈ \frac{{Σ}_{i = 1}^{{N}_{WT}} {A}_{i}^{{M}_{s} WT}}{{R}_{WT}} ⌉ - 1 ) \cdot \overline{{C}_{PV} ( t )} \\ {C}_{B} ( t ) = {C}_{B}^{1} ( t ) - {C}_{B}^{2} ( t ) \\ {C}_{B}^{1} ( t ) = ( ⌈ \frac{{Σ}_{i = 1}^{B} {A}_{i}^{{M}_{s} B}}{{R}_{B}} ⌉ - 1 ) \cdot \overline{{C}_{WT} ( t )} \cdot \overline{{C}_{PV} ( t )} \\ {C}_{B}^{2} ( t ) = ( 2 - ⌈ \frac{{Σ}_{i = 1}^{{N}_{B}} {A}_{i}^{{M}_{s} B}}{{R}_{B}} ⌉ ) \cdot ( {C}_{PV} ( t ) + {C}_{WT} ( t ) ) \\ {C}_{GE} ( t ) = ( ⌈ \frac{{Σ}_{i = 1}^{{N}_{GE}} {A}_{i}^{{M}_{s} GE}}{{R}_{GE}} ⌉ - 1 ) \cdot \overline{{C}_{B}^{1} ( t )} \cdot \overline{{C}_{WT} ( t )} \cdot \overline{{C}_{PV} ( t )}\end{matrix} \qquad ( 8 )$$

Where: C̅(̅t̅)̅ is the logical complement of C(t). It produces 1 when its operand is 0 and 0 when its operand is 1. The supplied electrical power to the microgrid φₖ(t) depends on that produced by sources Pₖ(t) (Equation 7) and their penetration states (Cₖ). These electrical powers are defined as follows:

$$\{ \begin{matrix}{P}_{PV} ( t ) = {C}_{PV} ( t ) \cdot {ϕ}_{PV} ( t ) \\ {P}_{WT} ( t ) = {C}_{WT} ( t ) \cdot {ϕ}_{WT} ( t ) \\ {P}_{B} ( t ) = {C}_{B} ( t ) \cdot {ϕ}_{B} ( t ) \\ {P}_{GE} ( t ) = {C}_{GE} ( t ) \cdot {ϕ}_{GE} ( t )\end{matrix} \qquad ( 9 )$$

To ensure the availability of power supply, the electric production delivered by four sources must be equal (or superior) to the consumption of the connected loads. The produced power can be expressed as follows:

P_{PV}(t)+P_{WT}(t)+P_{B}(t)+P_{GE}(t)≧Σᵢ₌₁^{NP}Cᵢ^{P}(t)·Pᵢ^{P}(t)+Cᵢ^{NP}(t)Σᵢ₌₁^{N}^{_{NP}}Cᵢ^{NP}(t)·Pᵢ^{NP}(t) (10)

where: (a) N_{P}: the number of critical loads, (b) N_{NP}: the number of uncritical loads, (c) Cᵢ^{P}, Pᵢ^{P}: the integration state and power of the i^{th} critical load, (d) Cᵢ^{NP}, Pᵢ^{NP}: the integration state and power of the i^{th} uncritical load, (e) C^{NP}: the integration state of the uncritical loads. In the platform, there are two critical and two uncritical loads. In the case of basic load shedding (without forecasting), the load shedding method takes into account only the real-time information about production and consumption as follows:

({Cᵢ^{P}(t)},{Cᵢ^{NP}(t)},{C^{NP}})=f(P_{PV}(t),P_{WT}(t),E_{Charge}(t),N_{Charge}(t),{Pᵢ^{P}},{Pᵢ^{NP}}) (11)

During the use of the backup sources, one has to avoid the total discharge of the batteries and also the tanks of the diesel generators. To avoid the phenomenon of sulfation, the batteries have to keep a minimum level E_{Charge} from which they stop supplying the microgrid. By analogy to batteries, the tanks of the diesel generators must have a minimum level N_{Charge} from which they disconnect from the microgrid in order to avoid any cavitation problem. The load shedding can be based on the classification of loads. In this case, the system can act to connect or disconnect uncritical loads (C^{NP}) (Switch C in FIG. 2). It can be based on the priority of loads. In this case, one may have a partial load shedding, and the control system can connect and disconnect loads belonging to the same class ({Cᵢ^{P}(t)}, {Cᵢ^{NP}(t)}) (Switches S1, S2, S3 and S4 in FIG. 2). The load shedding without a required forecasting can influence negatively on the availability of the electrical energy as follows:

If the system makes the decision of load shedding as soon as the renewable sources are unavailable, then the uncritical loads are disconnected at each short period of unavailability of renewable sources. In this case, the availability of the uncritical loads will be decreased in an unreasonable way,

In the case of unavailability of the renewable sources, any delay in the application of load shedding method decreases the autonomy of the backup sources quickly. This decrease influences negatively the availability of the critical loads in the case of a long downtime of renewable sources.

In order to guarantee the efficiency of this solution, the duration of the load shedding must be justified, which is based on the current state of sources and the duration of unavailability of the renewable sources (forecasting). In the case of a load shedding based on the forecasting, the uncritical load can be disconnected. The load shedding strategy can be re-written as follows:

({Cᵢ^{P}(t)},{Cᵢ^{NP}(t)},{C^{NP}})=f(P_{PV}(t),P_{WT}(t),φ_{GE}(t),φ_{B}(t),{Pᵢ^{P}},{Pᵢ^{NP}}) (12)

where, φ_{GE}(t) and φ_{B}(t) are the forecasted states of the backup sources: diesel generators and batteries, respectively.

$$\{ \begin{matrix}{ϕ}_{GE} ( t ) = ( ⌈ \frac{{Σ}_{i = 1}^{n} {E}_{Clim} ( t + i )}{n \cdot {E}_{{Clim}_{0}}} ⌉ - 1 ) \cdot ( ⌈ \frac{{Σ}_{i = 1}^{n} {N}_{R} ( t + i )}{n \cdot {N}_{{R}_{0}}} ⌉ - 1 ) \\ {ϕ}_{B} ( t ) = ( ⌈ \frac{{Σ}_{i = 1}^{n} {E}_{n} ( t + i )}{n \cdot {E}_{{n}_{0}}} ⌉ - 1 ) \cdot ( ⌈ \frac{{Σ}_{i = 1}^{n} {V}_{V} ( t + i )}{n \cdot {V}_{{V}_{0}}} ⌉ - 1 ) \\ \cdot ( ⌈ \frac{{Σ}_{i = 1}^{n} {N}_{Charge} ( t + i )}{n \cdot {N}_{{Charge}_{0}}} ⌉ - 1 )\end{matrix} \qquad ( 13 )$$

Master Consumption Agent:

The produced power in the microgrid may not be sufficient to satisfy the totality of power demand for all the time. For this reason, the specified priority must be defined between loads. In the case of an insufficient production, the loads with the highest priority will be supplied. In the considered case, there are two classes of priority: (i) priority loads: they are the critical loads that must be supplied in most of the time, and (ii) uncritical loads: they are uncritical loads that can be disconnected in the load-shedding phase (FIG. 4).

Master Load Agent:

One has two master load agents (critical and uncritical loads). To give more flexibility to the strategy of load shedding, the loads should have a second priority level. The same class priority loads can have different priority levels (FIG. 4).

Communication Strategy:

The communication between agents is done by tokens (FIG. 4). A token is a data table where the numbers of cells in this table is dependent on the number of agents by which the token passes. Each agent by whom the token passes, has its own cell in which it writes the information or receives the orders. This cell is accessible only by this agent and its master. The token has two types. It is an information token if its first bit is “0”, otherwise it is a control token with a first bit equals to “1”.

At the beginning of each control cycle, the super master agents (M A_{prod} and M A_{cons}) begin to collect information about the state of sources and loads. Initially, the batteries are considered as loads. The master agent of batteries M A_{B} is in a consumption mode, and it remains in this mode until the renewable sources are unavailable. In this case, M A_{B} becomes in a production mode and the batteries are considered as sources. M A_{B} returns in a production mode when the renewable sources become available;

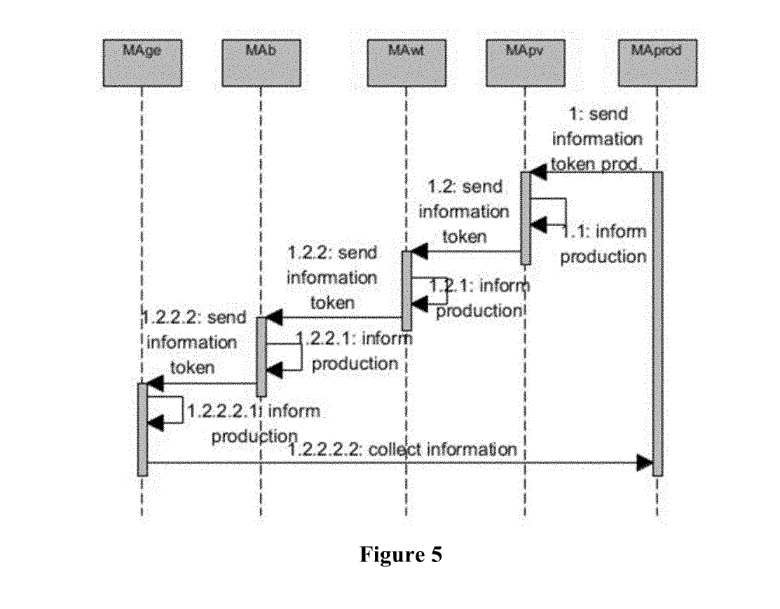

The production super master agent (M A_{prod}) sends a production information token (arrow for production token in FIG. 4) to its related master agents of production in order to determine the state of sources. The token visits the production agents (M A_{PV}, M A_{WT}, M A_{B} (if M A_{B} is in the production mode) and M A_{GE}) at first and returns thereafter to super master agents of production (M A_{prod}). Each master production agent when receives the token, sends an internal token to its slaves to collect information on the availability state of their micro-sources. When the agent receives the internal token again, it calculates the availability state of the source and fills its own cell in the production token information. FIG. 5 shows the UML sequence diagram of the production token information flow among agents. In this diagram, the batteries are in the production mode. The communication between each master agent and its slaves is represented as a self-message;

In the consumption management part, the super master agent of consumption collects the information on the energy loads. The super master agent sends consumption token information (arrow for consumption token in FIG. 4) to the loads master agents (M A_{P}, M A_{NP} and M A_{B} (if M A_{B} is in the consumption mode)). The priority loads agent (M A_{P}) sends an internal load information token to the related slaves in order to determine their energy demands. It calculates the total demand, fills and passes the token to the non-priority loads agent (M A_{NP}) that makes the same thing. After that, the token returns to the load master agents directly or passing by the master agent of batteries M A_{B} if it is in a consumption mode.

The two super master agents (M A_{prod} and M A_{cons}) negotiate on the level of production, which will be supplied by available sources to the connected loads, while taking into account the information collected by both super master agent and the meteorological forecast information provided by the meteo agent. These two super master agents select the adequate operation mode of batteries for the next control cycle.

After choosing the level of production, the super master agent of production sends a control token to the master production agents in order to integrate the highest priority available source and disconnect the others;

The master agents of sources to be disconnected send control tokens towards their slaves such that they disconnect their micro-sources. The master agent of the source to be connected has to choose the micro-sources to be penetrated while meeting the energy requirements. It then sends a control token to its slaves.

In the same way, the super master agent of consumption coordinates with loads master agents (M A_{P}, and M A_{NP}) in order to connect the most priority loads by taking into account the production level. If M A_{B} is in a consumption mode (renewable sources are available), then all the uncharged batteries are connected.

Implementation and Experimental Results:

In this section, one deals with the implementation of the control strategy and the experimental results.

Algorithms and Complexity:

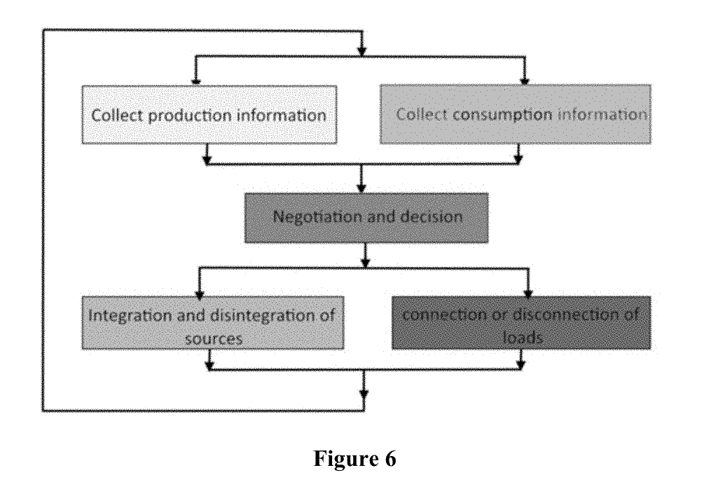

The control strategy can be divided into three stages (FIG. 6): (i) the collection of source production and load demand information, (ii) the decision phase, in which the control strategy should adjust the power generation level based on the information collected in the previous phase and taking into account the meteorological forecasting data, and (iii) the control phase, in this stage the control system reacts according to the chosen production level to connect or disconnect some sources and loads.

Renewable sources (photovoltaic generators and wind turbines) are sized to meet the entire demand of loads. If one of these two sources is available, then all the loads are powered. In the opposite case, the control system can decrease the level of production to increase the autonomy of backup sources (batteries and diesel generators). In this case, the production level depends on the available autonomy of these two sources and the time during which they operate. The minimization of production is surely followed by a reduction in consumption. The control system has to eliminate certain loads in order to guarantee the energy balance between the consumption and the production. The microgrid must allocate the power to priority loads first.

The control strategy is to allocate a specific priority for each load (load shedding). In the case when one has several loads and to facilitate the decision of the load shedding, it is better to classify the loads responsibilities which have a convergent priority degree. The load distribution by class should be balanced, and the number of loads by class should be approximately the number of classes.

Algorithm 1 Control Strategy Algorithm

| | |
|---|---|
| for each load agent do | end if |
| collect load information(Cp,Cnp) | else if autonomy ( [symbol] [symbol] [symbol] [symbol] [symbol] ) ≧ SBWD*Cp then |
| Cp [symbol] power demand of ( [symbol] [symbol] ,..., [symbol] [symbol] ) | calculate the production power level P = ( [symbol] [symbol] [symbol] )/SBWD |
| Cap [symbol] power demand of ( [symbol] [symbol] [symbol] ,..., [symbol] [symbol] ) | connect critical leads Cp |
| Lds [symbol] (Cp + Cap) | calculate the remaining available energy |
| end for | Pᵣₑₛₜ [symbol] P-Cp |
| for each source agent do | for [symbol] [symbol] [symbol] [symbol] [symbol] [symbol] [symbol] do |
| onflect source information (PV,WT,B,GE) | if Pₙₑₓₜ ≧ power demand of B_{NP} then |
| [symbol] [symbol] [symbol] [symbol] produced power of {S¹ [symbol] [symbol] ,..., S [symbol] [symbol] } | direct B_{NP} |
| [symbol] [symbol] [symbol] [symbol] produced power of { [symbol] [symbol] [symbol] ,..., S_{PV} [symbol] ^{WT}} | Pₙₑₓₜ [symbol] Pᵣₑₛₜ power demand [symbol] [symbol] [symbol] |
| [symbol] [symbol] [symbol] Autonomy of {Sₙ¹,...,S_{B}^{(NR)}} | else |
| [symbol] [symbol] [symbol] [symbol] Autonomy of {S¹ [symbol] [symbol] ,... S [symbol] [symbol] ⁽ [symbol] ⁾} | disconnect [symbol] [symbol] [symbol] |
| production information [symbol] ( [symbol] [symbol] [symbol] [symbol] [symbol] [symbol] [symbol] ) | end if |
| calculate availability | end for |
| end for | else |
| if(( [symbol] [symbol] [symbol] [symbol] [symbol] [symbol] [symbol] ≧ [symbol] demand of Lds then | disconnect critical loads Cop |
| if ( [symbol] [symbol] [symbol] ≧ Lds then | calculate the production power lead [symbol] [symbol] [symbol] /SBWD |
| request production from PV | Pᵣₑₛₜ < P |
| connect all leads | for j = I to N_{P} do |
| else if ( [symbol] [symbol] [symbol] [symbol] ≧ Lds then | if Pᵣₑₛₜ ≧ power demand of [symbol] [symbol] then |
| request production from WT | Connect [symbol] [symbol] |
| content all leads | Pᵣₑₛₜ [symbol] Pᵣₑₛₜ - power demand of [symbol] [symbol] |
| end if | else |
| else | Disconnect [symbol] [symbol] |
| connect seccessive bad weather days (SBWD) | end if |
| if autonomy [symbol] [symbol] [symbol] [symbol] [symbol] [symbol] ≧ SBWD*Lds then | end for |
| connect all leads | end if |
| if [symbol] [symbol] > 0 then | end if |
| request production from B | If no(bad weather) then |
| else if [symbol] [symbol] [symbol] > 0 then | refuelling GE |
| request production from GE | end if |

[symbol]

indicates data missing or illegible when filed

In the present invention, one has two priority classes: C^{P} for critical (Priority loads) and C^{NP} for uncritical (Non-priority loads). One has N_{P} critical loads β_{P}ⁱ (iε{1, . . . , N_{P}}). Each β_{P}ⁱ requests Pᵢ^{P} of energy. One has N_{NP} uncritical loads β_{NP}ⁱ (iε{1, . . . , N_{NP}}). Each β_{P}ⁱ requests Pᵢ^{NP} of energy. If one or both of renewable sources are available, then the control system integrates the source which has the highest priority, and all loads (critical and uncritical loads) are connected and powered. If these sources are not available, then the backup sources (batteries and diesel generators) must be used. The system makes a time estimation in which these sources have to insure the production (SBWD). If these sources can supply the requested power to all the loads during this period, then the production level remains constant and the system continues to supply all of loads. In the contrary case, the system minimizes the production according to the autonomy of the available backup sources. The produced energy will be allocated to the loads which belong to the highest priority classes. The rest of the produced power will be allocated to the higher priority loads of the next class.

Implementation of Multi-Agent Architecture:

For technical and economic reasons, one chooses the “Spartan 6” (XC6LX16-CS324) for the implementation of the proposed control strategy. This professional development board is ideal for fast learning modern digital design techniques. It presents a perfect solution for multi input/output control implementation. The development of the control strategy is done by Xilinx Mtalab Simulink. This software gives one the ability to build and test the control model (via a xilinx library) and implement it in FPGA (Petko (2004)). The Simulink model of the proposed strategy is composed of: (i) Four subsystems that represent the master agents of the four types of sources, (ii) A master agent for critical loads and another one for uncritical loads, (iii) Two super master agents which control all other agents: the super master agent of production and that of consumption, and (iv) An agent for meteorological forecasting data. This model can be subdivided into two big communicating parts. The first part groups the agents which manage the production of various sources. The second part includes the agents responsible of the energy consumption management of loads. These two parts are connected to negotiate the level of production that will be provided by the sources.

Experimental Results:

In order to guarantee the performance of the better energy management that is theoretically proposed, the strategy of control must be tested in similar simulations to those that cause the stops of the platform. CIPEM company (www.cipem.com.tn) gave one the necessary information concerning dates and durations of the breakdowns. These simulations are based on climatic history (insolation, wind speed) of the platform. The national institute of the meteorology in Tunisia supplies one these data (www.meteo.tn).

For the experimental setup, a real scenario that causes a total power failure in Tunisia in April 2013 is used. Several simulation results that highlight the influence of the control strategy on the power supply availability are presented and discussed. In the results, one uses two power supply availability rates (A_{PS}(%)) for: (i) critical loads, and (ii) uncritical loads. The instantaneous availability may have only two values, 1 in the case of availability and 0 in the opposite case. The average availability A_{A}(t) is the mean value of the instantaneous availability between time=0 and time=t.

$${A}_{PS} ( t ) = \frac{1}{t} {\int }_{0}^{t} A ( x ) dx \qquad ( 14 )$$

One focuses mainly on the choice of the production level and its effect on the autonomy of the backup sources. This section represents a comparison between three strategies of control:

The first strategy consists in supplying all loads in the case of availability of sources. In this case, the level of production is fixed (without a load shedding);

The second strategy consists in the load shedding of uncritical loads if the diesel generators are the only available sources in order to increase their autonomy. The load shedding decision is based only on the real-time information about the availability state of sources;

The third strategy presents the invention's contribution that deals with the load shedding method based on the forecasting information. If the system predicts a long unavailability of the renewable sources, then the load shedding begins when the system uses the backup sources.

The conditions under which one makes the comparison are: (i) the renewable sources are unavailable for 6 units of time (between t=3 and t=9), (ii) the batteries can recover the energy demand of loads during two units of time, and (iii) the diesel generators can recover the energy demand of loads during only one unit of time. There are two production levels: (i) 100%, all loads will be supplied, and (ii) 50%, only critical loads will be supplied. As shown previously, the penetration is equal to: (i) “1” if the source is connected to the grid, (ii) “0” if the source is disconnected from the grid, and (iii) “−1” for the batteries in their charging phase.

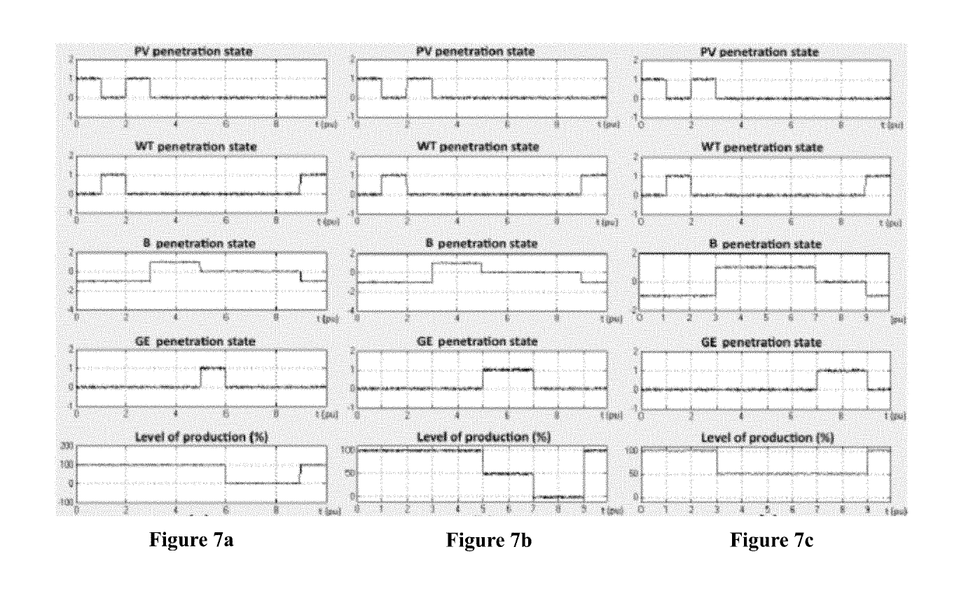

In the first case (without any load shedding): During the phase of unavailability of renewable sources, the system continues to supply all of the loads. The backup sources assure the energy demand during 3 units of time. The system becomes in a total stop (at t=6) during 3 units of time (FIG. 7a). In this case, A_{PS}(%) is equal to 70% for both types of loads (critical and uncritical loads).

In the second case (with a load shedding): the level of production is maximal (100%) during the phase of availability of the renewable sources or of the battery. When these sources become unavailable, the system uses the diesel generators to supply the loads and reduce automatically the level of production by using the load shedding method. The reduction of the production (50%) doubles the autonomy of this source. The system becomes in a total stop (at t=7) for only 2 units of time (FIG. 7b). In this case, A_{PS}(%) for critical loads increases to 80%, and A_{PS}(%) for uncritical loads decreases to 60%.

In the third case (with a load shedding and with a forecasting-based control): The system predicts a long unavailability of renewable sources. When these sources become unavailable, the control system takes a decision for a load shedding. The production level is reduced by a half in this case and the autonomy of batteries and diesel generators is doubled. These sources can recover the energy demand during the unavailability phase of the renewable sources (FIG. 7c). In this case, A_{PS}(%) for critical loads increases and achieves the total availability (100%), and A_{PS}(%) for uncritical loads decreases to 40%.

In the case of a long downtime of the renewable sources, the system must promote the priority loads in order to avoid their stops. The comparison shows that the system should make an early decision for a load shedding. The load shedding strategy should be based on forecasting information.

Interpretation:

The experimental results show clearly that the proposed control strategy increases A_{PS}(%) of critical loads. In cases of insufficient production, the allocation of the available power became more reasonable. According to the obtained results, it can be seen that:

An adequate choice and size of sources increase the availability of power supply. However, when one chooses the sources, the reconfiguration is costly and takes time. Economically, this kind of solution is very expensive;

The load shedding is a very important strategy to increase the availability of electric power of critical loads in the case of insufficient production, but it decreases this availability rate for the non-priority loads and the system;

The load shedding can be based on real-time information and a forecasting-based control. The right choice of the command and the forecasting methods provide a very high availability level of critical loads which can reach 100%;

The use of the multi-agent system in the power management of a microgrid decreases the complexity of the control strategy. It is an efficient way to solve several complex problems locally. This way makes the control strategy more flexible and more autonomous;

The presence of individual agents for each category of units reduces the complexity of the control strategy. It facilitates the collection of information, the decision and the control of the various units of microgrid.

In order to ensure high availability in the island and autonomous microgrid, one propose a new forecasting-based solution for better energy management. The major problem of this solution is the probabilistic aspect of the forecasting data on which the strategy is based to make its decision. The load shedding increases the availability in the level of critical loads; but in return, this method decreases the availability in the level of uncritical loads without having any negative effect. Despite its problems, this strategy provides good results in a case study. The predictive control strategy can help a microgrid to improve the power supply availability by proactive control. Comparing with existing solutions, the proposed new solution presents several economical and technical benefits.

The proposed control strategy increases the energy autonomy of the platform. In the considered case study, this method doubles the autonomy of the backup sources. By a historic analysis, this improvement can assure the continuity of production in the platform. The platform can avoid losses caused by the power unavailability. The use of FPGA to implement the proposed multi-agent architecture represents another technical originality for the present invention.

The performance of the proposed solution depends on the weather forecasting estimations as inputs to the fixed problem. The proposed control strategy presents a better solution especially for the applications (such as an islanded petroleum platform) where the resizing of sources is not feasible because of some constraints (space and weight).

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but is not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. A computer-implemented method for managing connections of sources and loads to a network of a grid to optimize power supply availability, the grid comprising a set of loads, a set of sources, a set of agents for energy management, and a meteorological database having meteorological forecasting data, the method comprising:
collecting, by at least one of the agents, sources production information from the set of the sources;
collecting, by at least one of the agents, loads demand information from the set of the loads;
determining, by at least one of the agents, a power generation level based on the collected sources production information, the loads demand information and the meteorological forecasting data;
connecting or disconnecting, by at least one of the agents, some of the sources to the network based on the power generation level; and
connecting or disconnecting, by at least one of the agents, some of the loads to the network based on the power generation level.

2. The method of claim 1, wherein the set of the loads comprises one or more critical loads and one or more uncritical loads, wherein the critical loads are connected to the network, and the uncritical loads are disconnect-able from the network.

3. The method of claim 1, wherein the set of the sources comprises one or more renewable sources and one or more backup sources.

4. The method of claim 3, wherein the renewable source includes a photovoltaic generator, or a wind turbine.

5. The method of claim 3, wherein generation of the renewable source depends on one or more meteorological factors.

6. The method of claim 3, wherein the stock source includes a battery, or a diesel generator.

7. The method of claim 3, wherein the sources production information includes power produced by the renewable sources and autonomy of the backup sources.

8. The method of claim 3, wherein the loads demand information includes power demand of the critical loads and power demand of the uncritical loads.

9. The method of claim 1, wherein the grid is a microgrid in an island mode.

10. A computer-implemented method for managing connections of sources and loads to a network of a grid to optimize power supply availability, the grid comprising a set of loads, a set of sources, and a set of agents for energy management, the method comprising:
collecting, by a super master production agent, state information of the sources;
collecting, by a super master consumption agent, state information of the loads;
sending, by the super master production agent, a production information token to its related master production agents in order to determine a state of the sources, wherein the production information token visits the master production agents and returns thereafter to the super master production agent;
sending, by each of the master production agents, an internal token to its slaves to collect information on an availability state of their micro-sources;
calculating, by each of the master production agents, the availability state of the sources and filling its own cell in production token information when the master production agent receives the internal token again;
collecting, by the super master consumption agent, information on the loads;
sending, by the super master consumption agent, consumption token information to its related master load agents;
sending, by a priority load agent, an internal load information token to its related slaves in order to determine their energy demands;
calculating, by the priority load agent, a total demand;
filling and passing, by the priority load agent, the internal load information token to a non-priority load agent;
negotiating, by the super master production agent and the super master consumption agent, on a level of production being supplied by available sources to connected loads, while taking into account the information collected by both of the super master production and consumption agents and meteorological forecast information provided by a meteo agent;
sending, by the super master production agent, a control token to the master production agents in order to integrate highest priority available source and disconnect the others;
sending, by master agents of source to be disconnected, control tokens towards their slaves such that they disconnect their microstates;
choosing, by a master agent of the source to be connected, micro-sources to be penetrated while meeting energy requirements, then sending a control token to its slaves; and
coordinating, by the super master consumption agent, with the master load agents in order to connect most priority loads by taking into account the production level.

11. The method of claim 10, wherein the set of the loads comprises one or more critical loads and one or more uncritical loads, wherein the critical loads are connected to the network, and the uncritical loads are disconnect-able from the network.

12. The method of claim 10, wherein the set of the sources comprises one or more renewable sources and one or more backup sources.

13. The method of claim 12, wherein the renewable source includes a photovoltaic generator, or a wind turbine.

14. The method of claim 12, wherein generation of the renewable source depends on one or more meteorological factors.

15. The method of claim 12, wherein the stock source includes a battery, or a diesel generator.

16. The method of claim 10, wherein the grid is a microgrid in an island mode.
